(19) United States
(12) Patent Application Publication
(10) Pub. No.: US 2007/0181834 A1
(43) Pub. Date: Aug. 9, 2007

(54) ARRANGEMENT AND METHOD FOR THE GENERATION OF EUV RADIATION OF HIGH AVERAGE OUTPUT

(75) Inventor: JUERGEN KLEINSCHMIDT, Goettingen (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: XTREME technologies GmbH

(21) Appl. No.: 11/622,241

(22) Filed: Jan. 11, 2007

(30) Foreign Application Priority Data
Jan. 24, 2006 (DE) 10 2006 003 683.2

(51) Int. Cl. G01J 3/10

(52) U.S. Cl. 250/504 R

(57) ABSTRACT

The invention is directed to an arrangement and a method for the generation of EUV radiation of high average output, preferably for the wavelength region of 13.5 nm for use in semiconductor lithography. It is the object of the invention to find a novel possibility for generating EUV radiation of high average output which permits a time-multiplexing of the radiation of a plurality of source modules in a simple manner without overloading the source modules and without requiring extremely high rotational speeds of optical-mechanical components. This object is met, according to the invention, in that a plurality of identically constructed source modules which are arranged so as to be distributed around a common optical axis are directed to a rotatably mounted reflector arrangement which successively couples in the beam bundles of the source modules along the optical axis. The reflector arrangement has a drive unit by which a reflecting optical element is adjustable so as to be stopped temporarily in angular positions that are defined for the source modules and is oriented to the next source module in intervals between two exposure fields of a wafer by means of control signals emitted by an exposure system.

### CROSS-REFERENCE TO RELATED APPLICATION

This application claims priority German Application No. 10 2006 003 683.2, filed Jan. 24, 2006, the complete disclosure of which is hereby incorporated by reference.

### BACKGROUND OF THE INVENTION

1. a) Field of the Invention

The invention is directed to an arrangement and a method for the generation of EUV radiation of high average output for the lithographic exposure of wafers, wherein a plurality of identically constructed source modules which are distributed in a vacuum chamber around an optical axis of the vacuum chamber are triggered successively for generating beam bundles from plasma emitting EUV radiation in order to couple in their beam bundles in direction of the common optical is by means of a reflector arrangement which is mounted so as to be rotatable. The invention is applied in radiation sources for semiconductor lithography, preferably for the wavelength region of 13.5 nm.

2. b) Description of the Related Art

In semiconductor lithography, structural widths of ≦32 nm are generated by means of EUV radiation (chiefly in the wavelength region of 13.5 nm). Recently, pulse repetition frequencies of about 6 kHz (see, e.g., V. Banine et al., Proc. of SPIE 3997 (2000) 126) and “in-band” radiation outputs of >600 W/2π for the EUV sources to be used have been discussed for achieving an economically feasible throughput of 100 wafers per hour in the semiconductor industry using this technology.

These output requirements correspond to an initial pulse energy of 100 mJ/2π·sr or 16 mJ/sr. While these energy values were already achieved in the years 2002 and 2003 with xenon gas discharge sources at a low pulse repetition frequency, these outputs already represented a substantial thermal load for the source modules at a repetition rate of 6 kHz. Therefore, for the quasi-continuous operation of an EUV source, U.S. Pat. No. 6,946,669 B2 and German Patent DE 103 05 701 B4 described a multiple arrangement of complete source modules with debris filters and radiation collectors for reducing thermal loading in which a continuously rotating mirror was arranged downstream of the collectors of the individual source modules for sequentially coupling the radiation into a common intermediate focus. This mirror reflects the EUV radiation of the individual source modules in direction of the application (exposure optics for semiconductor lithography) in a constant sequence with respect to time. The average thermal loading per source collector module is reduced by a factor equal to the number of source modules employed.

The output requirements mentioned above (600 W/2π, approximately 6 kHz) are now no longer sufficient because, among other reasons, they are based on overly optimistic estimates of the attainable resist sensitivity (a measure for the least amount of EUV radiation energy to be deposited per surface unit for the necessary photoresist ablation) and on the assumption that collector optics with acceptance angles of about 1π·sr and an average reflectivity of ≧55% (see Table 1) can be realized.

TABLE 1
Output requirements for EUV sources with geometric and transmission
losses (positions 2–6) as defined in the year 2000:

| | | |
|---|---|---|
| 1 | Output in the intermediate focus [W] | 115 |
| 2 | Collection efficiency (punctiform emission) [sr/2π · sr] | 0.50 |
| 3 | Average reflectivity of the collector optics | 0.55 |
| 4 | Transmission of the debris filter (DMT) | 0.82 |
| 5 | Gas transmission | 0.85 |
| 6 | Reduction factor of the collection efficiency due to | 1.00 |
| | expanded emission volume | |
| 7 | EUV in-band output [W/2π · sr] | 600 |
| | (EUV in-band: 13.5 nm ± 2% | |

The EUV radiation output in the intermediate focus defined according to Table 1 (line 1) for the required throughput of 100 wafers per hour is based on resist sensitivities RE=5 mJ/cm² which were assumed to be realistic at that time.

However, as a result of findings of recent feasibility studies, the requirements for an EUV radiation source suitable for production lines in semiconductor lithography have been raised considerably in connection with the following principal points:
1. It is known that the reflectivity of reflection optics with grazing incidence (grazing incidence optics) decreases considerably as the angle of incidence increases (relative to the mirror surface) and, therefore, the collection efficiency does not scale linearly with the collecting solid angle. The use of π·sr collectors (Table 1) is possibly accompanied by a reflectivity of less than 55%. Therefore, in the future, grazing incidence collectors will have collecting solid angles of 2 sr to π·sr in connection with a collection efficiency of 0.3 to 0.5.
2. Recent studies (V. Banine, EUVL Symposium, San Diego, Nov. 7-10, 2005) show that the resist sensitivity for EUV radiation will possibly be in the range of >5 mJ/cm² to 10 mJ/cm². Accordingly, in order to achieve the same wafer throughput, the output in the intermediate focus must be increased to values of 200 W.

3. The typically strong emission lines especially for xenon and tin emitters in the spectral range of 130 nm to 400 nm necessitate the use of spectral filters (spectral purity filter). However, filters of this kind also reduce the radiation output in the EUV range (L. Smaenok, EUVL Symposium, San Diego, Nov. 7-10, 2005).

All of the points mentioned above indicate that EUV sources suitable for use in production lines must deliver average radiation outputs in the source location of >1200 W/2π. In view of the fact that the EUV initial pulse energy of a state-of-the-art source module cannot be substantially increased, the solution for achieving more than double the average output can only be realized by means of a pulse repetition frequency that is increased from 6 kHz to >12 kHz.

A technical solution of the type mentioned above is known from the prior art from U.S. Pat. No. 6,946,669 B2. At the high pulse repetition frequencies of more than 12 kHz discussed above, it has the disadvantage that the multiplexing of individual pulses of several EUV source modules by means of a continuously rotating mirror would require a rotary mirror drive with extremely high rotational speeds (>720,000 rpm/[quantity of source modules]). Although drives with rotational speeds of more than 200,000 rpm are available in principle, substantial problems are caused by the cooling of the rotary mirror required at such speeds in addition to the demanding requirements for the mechanical precision of the rotary mirror unit.

### OBJECT AND SUMMARY OF THE INVENTION

It is the primary object of the invention to find a novel possibility for generating EUV radiation of high average output which permits a time-multiplexing of the radiation of a plurality of source modules in a simple manner without overloading the source modules and without requiring extremely high rotational speeds of mechanical components.

An arrangement for generating EUV radiation of high average output for the lithographic exposure of wafers has a vacuum chamber for the generation of radiation, which vacuum chamber has an optieal axis for the EUV radiation when it exits the vacuum chamber, a plurality of identically constructed source modules are arranged so as to be distributed around the optical axis of the vacuum chamber, from which source modules a beam bundle generated from EUV radiation-emitting plasma is directed to a common intersection point with the optical axis, and a rotatably mounted reflector arrangement is arranged at the common intersection point of the beam bundles, which reflector arrangement couples the beam bundles prepared by the source modules into the optical axis in series. According to the invention, the above-stated object is met in this arrangement in that the reflector arrangement has a reflecting optical element which is mounted so as to be rotatable around an axis of rotation coaxial to the optical axis and which communicates with a drive unit and is adjustable on demand so as to be stopped temporarily in angular positions that are defined for the source modules, and in that the reflector arrangement communicates with an exposure system for lithographic exposure in order to initiate an orientation of the reflecting optical element to the next source module in intervals between exposures by means of control signals emitted by the exposure system.

The drive unit advantageously has a rotor which is rotatable around the optical axis by increments, and the reflecting optical element is directly connected to the rotor. The reflecting optical element is advisably a plane mirror or a plane optical grating. However, it can also be advantageous to use a suitably curved mirror or a curved optical grating as a reflecting optical element for additional focusing of the beam bundles of the source modules. The reflecting optical element is preferably constructed as a meandering grating with a suitable groove depth and grating constant.

When the reflecting optical element is formed as an optical grating, it can also be designed so as to be spectrally selective for the desired bandwidth of the EUV radiation that is transmissible by the optics downstream.

The reflector arrangement advisably has a stepper motor or a servo motor as a drive unit. It can advantageously be controlled by control signals of position-sensitive detectors in addition to the control signals from the exposure system. For this purpose, an auxiliary laser beam and position-sensitive detectors associated with the source modules for detecting and adjusting the angle of rotation of the reflecting optical element are advantageously provided.

In an advantageous construction, the reflector arrangement has two reflecting optical elements, a main mirror and an auxiliary mirror. The main mirror is provided for coupling in the EUV radiation of the active source module along the optical axis and the auxiliary mirror is designed to deflect EUV radiation of a passive source module to a detector for measuring output parameters.

The collector optics contained in the individual source modules are advisably grazing incidence optics, but can also be a nested Wolter collector.

It has proven advantageous for purposes of reducing shadowing when the collector optics used in the individual source modules are multilayer optics. Schwarzschild optics are preferably used for this purpose.

The source units in the individual source modules are preferably constructed as gas discharge sources. It is especially advantageous to use gas discharge sources having discharge arrangements with rotary electrodes.

The individual source modules are advantageously operated by separate high-voltage charging modules or share a common high-voltage charging module.

Further, in a method for the generation of EUV radiation of high average output for the lithographic exposure of wafers in which a plurality of identically constructed source modules which are arranged in a vacuum chamber so as to be uniformly distributed around an optical axis of the vacuum chamber are triggered successively for generating beam bundles of EUV radiation-emitting plasma in order to couple in their beam bundles in direction of the optical axis by means of a reflector arrangement which is mounted so as to be rotatable, the object of the invention is met by the following steps:

1) The reflector arrangement is rotated for coupling in the beam bundle of a first source module along the optical axis simultaneous with the adjustment of a first exposure field of the wafer in a lithographic exposure system;

2) The first source module is triggered in a burst regime with a high pulse repetition frequency and enough pulses so that the entire first exposure field is completely exposed by pulses from the first source module;

3) The reflector arrangement is rotated for coupling in a next source module simultaneous with the adjustment of a next exposure field within an interval between exposures after the preceding exposure of an exposure field;

4) The next coupled-in source module is triggered in a burst regime with the same pulse repetition frequency and number of pulses as the first source module so that the current exposure field is completely exposed with pulses from this source module;

5) Steps 3) and 4) are repeated, and all of the source modules are coupled in one after the other for the complete exposure of a respective exposure field until the last exposure field of the wafer is exposed.

The invention is based on the fundamental idea that it is indispensable for reducing the thermal loading of EUV sources to carry out time-multiplexing of a plurality of complete source modules by means of a reflector arrangement in that the individual pulses of the source modules are successively coupled into the same light path by a rapidly rotating mirror in order to achieve an increase in the average EUV output of the total source with reasonable thermal loading of the individual source modules.

However, in view of the fact that it is no longer feasible for technical reasons to combine the individual pulses of the source modules successively to form a high-frequency pulse sequence because of the increased output requirement for the total source due to the need for increased pulse repetition frequencies (>12 kHz), the rotary mirror is not rotated continuously at a constant speed but rather, according to the invention, in order to simplify the reflector arrangement, is rotated further to the position of the next source module only in intervals between exposures after individual exposure sequences (bursts) by means of a drive unit which is controllable in a desired incremental manner.

The solution according to the invention makes it possible to generate EUV radiation of high average output by means of a high pulse repetition frequency, and a time-multiplexing of the radiation of a plurality of source modules is achieved in a simple manner without excessive thermal loading of the source modules and without extremely high rotating speeds of mechanical components.

The invention will be described more fully in the following with reference to embodiment examples.

### BRIEF DESCRIPTION OF THE DRAWINGS

In the drawings:

FIG. 1 shows a schematic view of the invention with two source modules with two angular adjustments of the reflector arrangement;

FIG. 2 shows a schematic diagram illustrating the wafer exposure in semiconductor lithography;

FIG. 3 shows a construction of the invention with two source modules, an auxiliary laser beam and two position-sensitive detectors;

FIG. 4 shows the exposure schedule for a 300-mm wafer in an arrangement with three source modules;

FIG. 5 shows the EUV source modules and rotary mirror controlled by control signals of the exposure system and position-sensitive detectors; and

FIG. 6 shows a construction of the invention with an auxiliary mirror and monitoring detector for additional source module testing in a passive circuit.

### DESCRIPTION OF THE PREFERRED EMBODIMENTS

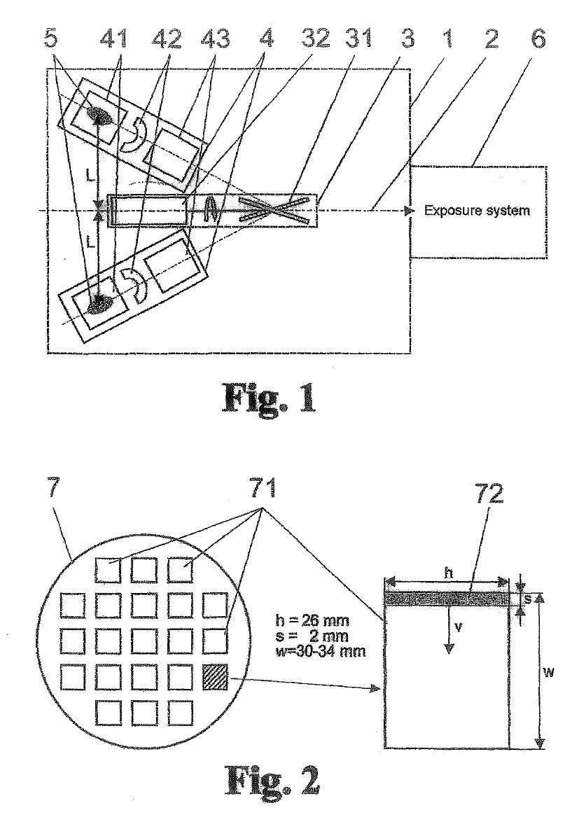

In a basic variant, as is shown in FIG. 1, the arrangement according to the invention has a plurality of (in this case, two) source modules 4 which generate EUV radiation independently in each case in any conventional manner (Z-pinch, hollow-cathode triggered pinch or plasma focus arrangements). The use of a discharge arrangement with rotating electrodes as is known, e.g., from EP 1 401 248 is advantageous for the life of the EUV source. Further, the arrangement contains within a vacuum chamber 1 a reflector arrangement 3 which comprises a rotary mirror 31 and a drive unit 32 and which couples in the beam bundles of all of the source modules 4 successively in a stepwise manner on an optical axis 2 in direction of the exposure system 6 after an entire sequence of pulses 45 of each of the source modules 4 has been coupled in.

Each of these source modules 4 by itself is capable of operating at a pulse repetition frequency of >12 kHz for purposes of an acceptable thermal loading at least over a pulse sequence (burst) of more than 1000 pulses 45. The duration of this burst is limited to a few hundredths of a second (e.g., 0.13 s).

Besides the source unit 41 for generating a plasma 5, each source module 4 contains a device for debris suppression (DMT) 42 and collector optics 43. Nested multi-shell optics for grazing incidence (grazing incidence optics) are preferably used as collector optics 43. However, collector optics 43 of this kind have certain disadvantages due to shadowing caused by the end faces of the collector shells and because of complicated cooling structures resulting from the filigree construction of the collector shells. Therefore, optics with multi-layer mirrors, e.g., in the form of Cassegrain optics or Schwarzschild optics, are also advisably used for high-output EUV sources because of their more favorable cooling possibilities. When combined with the rotary mirror 31, such collectors 43 with multilayer mirrors have the advantage that they reflect in a spectrally selective manner, and therefore substantially only EUV radiation components reach the rotary mirror 31 so that the thermal loading of the latter is reduced.

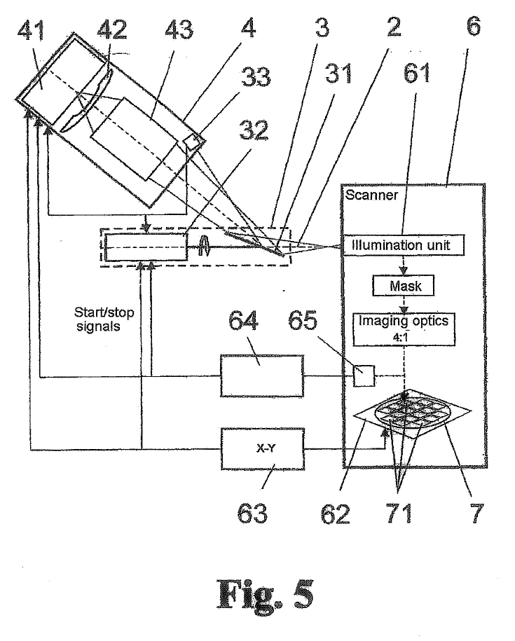

In the following, reference is had to FIG. 5 in addition to FIG. 1 for illustrating the control of the reflector arrangement 3. Only one source module is shown in FIG. 5 for the sake of clarity.

In order to expose the first exposure field 71 (die) of the wafer 7, the drive unit 32 of the rotary mirror 31 is rotated by a signal from the exposure system 6 (also often called a scanner) into an angular position in which the EUV radiation of the source module 4′ is reflected along the optical axis 2 in direction of the illumination system 6. Upon command by the exposure system 6, the source module 4′ emits EUV radiation pulses over a predetermined exposure period at a sufficiently high repetition frequency (≧12 kHz).

The exposure time T=0.13 s for an exposure field 71 is given by the area (h×w) ≈26 mm×33 mm of the exposure field 71 (see, e.g., FIG. 2), the resist sensitivity RE=10 mJ/cm² and the EUV radiation output (P=0.62 W) required on the surface of the wafer 7:

T=w/v=(h·w·RE)/P,

where v represents the movement speed of a line focus 71 (see also FIG. 2 and the accompanying description) moving in direction h over the surface of the exposure field 71. With a regime of 12 kHz, the exposure time corresponds to a pulse sequence (a burst 44) with 1560 pulses 45.

When the wafer 7 is positioned in a highly accurate manner in a start position of the X—Y table system 62 which determines a first exposure field 71 for exposure with EUV radiation by means of a lithographic exposure system 6 and the rotary mirror 31 is oriented at the same time for coupling in a first source module 4′ in direction of the exposure system 6, the source module 4′ receives a start signal for emitting EUV radiation in a pulse sequence (burst) calculated in the manner as shown above.

After the exposure of a first exposure field 71, the X—Y table system 62 moves the wafer 7 to the position of the second exposure field 71. At the same time, the drive unit 32 receives the command to rotate the rotary mirror 31 to an angular position in which the EUV radiation of the next source module 4″ is reflected in direction of the illumination system 6. In this position, the drive unit 32 stops and the coupled-in source module 4″ receives (at the expiration of the time for exact wafer positioning) the control command for emitting the next burst 44 (with the predetermined average output, pulse repetition frequency and duration) for exposing the second exposure field 71. The wafer 7 and the rotary mirror 31 are then repositioned for exposing the third exposure field 71 with the next source module 4″, and so on.

The actual rotations of the drive unit 32 of the rotary mirror 31 take place exclusively during the intervals between exposures in which the wafer 7 is displaced (die-to-die shift) between two exposure fields 71 in any case. The drive unit 32 and rotary mirror 31 are stationary during the exposure.

In the following, the operating regime according to the invention will be described using the example of EUV exposure of 300-mm wafers with a resist sensitivity of 10 mJ/cm² for a required throughput of 100 wafers per hour.

The required EUV radiation output P on the wafer 7 at the required throughput of 100 wafers/h is determined by the resist sensitivity RE, the surface to be effectively illuminated per wafer 7 (sum of the surfaces of the individual exposure fields 71) and the effective exposure period (sums of the exposure times per exposure field 71). However, the effective exposure period per wafer 7 is overlapped by a time period T_{woh} for the entire X—Y table control 63 of the wafer 7 (shifting from exposure field 71 to exposure field 71, overlay control, and so on) which is also known as the “stage overhead time” for a wafer 7. The time period T_{woh} for a 300-mm wafer is typically 27 s (see Table 2). Consequently, the effective exposure period per wafer is 36 s−T_{woh}=9 s.

Since 80% of the total wafer surface must usually be exposed in case of 300-mm wafers, the required EUV radiation output on the wafer 7 with a resist sensitivity RE=10 mJ/cm² is P=0.62 W in order to maintain a throughput of 100 wafers/h. The following Table 2 shows an overview of all of the boundary conditions for the EUV exposure process of a 300-mm wafer.

TABLE 2
Parameters for the lithographic exposure process for a 300-mm
wafer at a throughput of 100 wafers/h.
Wafer parameters

| | | |
|---|---|---|
| wafer diameter | 300 | mm |
| total wafer surface | 705 | cm² |
| exposed surface/total surface | 0.8 | |
| resist sensitivity | 10.0 | mJ/cm² |

time regime

| | | |
|---|---|---|
| total duration of the exposure procedure for 1 wafer | 36 | s |
| table control time T_{woh} (stage overhead time) | 27 | s |
| effective exposure time for all fields (dies) | 9.0 | s |
| EUV output in the wafer plane | 0.62 | W |

Table 2 shows that as a result of the transmission of the illumination optics τ_{B}≈8%, the reflectivity of the mask R≈65% and the transmission of the imaging optics τ_{A}≈7% and, with an output reserve factor of ≈1.2, an EUV radiation output of P≧200 W is necessary in the intermediate focus which, according to the above estimates at the source location (plasma 5), requires an EUV in-band radiation output of ≧1200 W/2π·sr.

In light of the fact that outputs of >800 W/2π·sr have been reached in gas discharge sources using tin (Sn) as target material at repetition frequencies of 5 kHz within short pulse sequences (bursts 44) of about one thousand radiation pulses 45 (U. Stamm et al., EUVL Symposium, San Diego, Nov. 7-10, 2005) and assuming that the wafer exposure in a lithographic scanner (exposure system 6) is always carried out in a burst regime, the above-described multiplexing regime with a plurality of source modules 4 can be successfully used in continuous operation for EUV sources that are suitable for production lines in that the source modules 4 are operated in so-called burst regime.

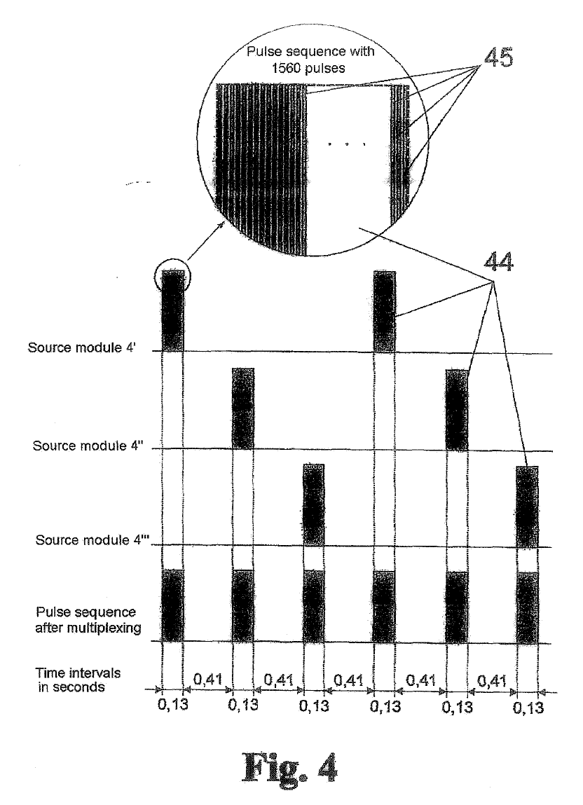

In the burst regime of the source modules 4 in which, as is shown in FIG. 4, bursts 44 with pulse repetition frequencies of >12 kHz are emitted, average radiation outputs of more than 1200 W/2π can be achieved within each individual burst 44 without thermal overloading of the individual source modules 4 because there is sufficient time available in the intervals between exposures and in the exposure phases in which another source module 4′, 4″ or 4′″ is active (see FIG. 4) for the excess heat to be carried off.

A conventional wafer exposure regime is shown schematically in FIG. 2. During the exposure of an exposure field 71, a line focus 72 (moving slit) of dimensions h×s is moved over a small rectangular area h×w of the wafer 7 at a speed v=P/(RE·h). Within this process, this exposure field 71 is irradiated by a pulse sequence (burst 44) of EUV radiation pulses 45. An X—Y table system 62 (see FIG. 5) then moves the wafer 7 to the position of the next exposure field 71.

The angle adjustment accuracy of the drive unit 32 for the rotary mirror 31 is determined by the requirement for the accuracy of the adjustment of the emission centroid of the EUV-emitting volume by <±0.1 mm perpendicular to the optical axis 2 (see schematic drawing FIG. 1), Accordingly, it is ±0.1 mm/L, where the centroid of the emission volume has the perpendicular distance L from the axis of rotation 2 of the rotary mirror 31. The distance L is advisably selected in the range of 500 mm and therefore gives an angle adjustment accuracy of ±0.2 mrad.

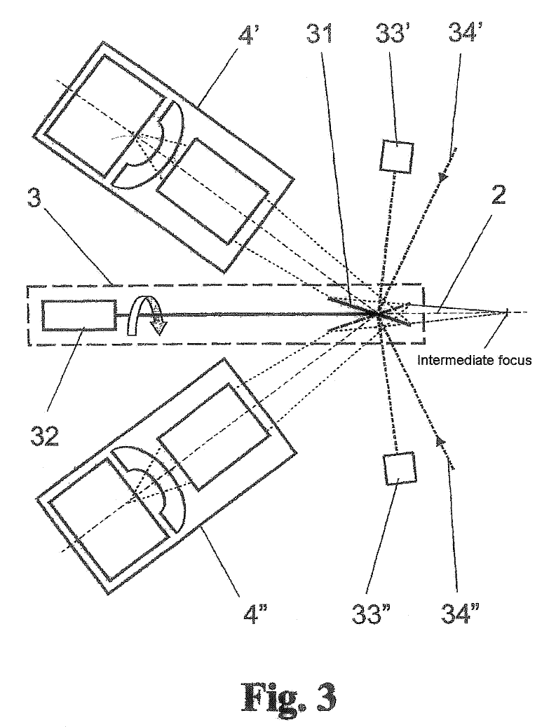

The step resolution of the drive unit 32 for the rotary mirror 31 should either be adjustable to better than ±0.05 mrad (25% of the permitted angle indeterminacy), or additional detectors 33 must be provided according to FIG. 3 which report when the reference position of the rotary mirror 31 is reached in order to stop the drive unit 32.

For this purpose, every source module 4′ and 4″ according to FIG. 3 has a position-sensitive detector 33′ and 33″, respectively. As is shown in FIG. 3, an additional auxiliary laser beam 34′ and 34″ is preferably provided which is reflected at the rotating mirror surface and which impinges on the position-sensitive detectors 33′ or 33″ at a corresponding angular position of the rotary mirror 31 and accordingly generates an electric signal which stops the drive unit 32 of the rotary mirror 31 and, at the same time, triggers the radiation emission with the coupled in source collector module 4′ or 4″.

Servo motors, for example, are suitable as drive units 32 because of their characteristic properties:
large angular acceleration (servo motors can accelerate from zero to the rated rotational speed in a few milliseconds and can brake equally fast);
typical rated rotational speeds between 3000 and 6000 rpm =50 to 100 rps (only several milliseconds are required for rotating to the position of the next source module at, e.g., three of all source modules arranged in an equally distributed manner by 120°);
high resolving capacity for the angular position. (In modem mechatronics, it is possible to achieve a resolution of >2¹⁶=65,536 steps per revolution [peak values of up to 2¹⁶] in servo motors with angle measurement systems [optical readout of coded disks]. Resolutions of up to 0.6 arc seconds are even possible with sine-cosine encoders).

FIG. 4 shows the flow diagram for controlling the source modules 4′ and 4″ and the multiplex mode of the drive unit 32. This is predicated on the following:

For the exposure of a 300-mm wafer with an 80% effective exposure field (56520 mm²), 66 exposure fields 71 (dies), each having a surface of 26 mm×33 mm, must be exposed. The basic exposure time for an exposure field 71 is 0.13 s. For this purpose, for each wafer 7, there is a time period of 27 s for the wafer control (die-to-die shift) and position monitoring, so that there is an added time for control of 27 s/66=0.41 s per exposure field 71 for the 300-mm wafer in each exposure step.

As is shown schematically in FIG. 4, the exposure of a die is carried out by a burst 44 of 1560 pulses 45 with a pulse repetition frequency of 12 kHz. The burst 44 is emitted in its entirety from one of the EUV source modules 4. FIG. 4 shows an exposure regime of this kind for a multiplexing arrangement of three source modules 4. Switching between the individual source modules 4′, 4″ and 4′″ is carried out exclusively after a complete burst 44, i.e., after the complete exposure of an exposure field 71 (die).

According to FIG. 5, the exposure procedure proceeds in the following manner. Since the control is illustrated in a simplified manner, FIG. 5 shows only one source module 4 so that reference is had again to FIG. 3 for the description of the separate source modules 4′ and 4″.

The exposure system 6 is in the starting position for exposing the first exposure field 71 of the wafer 7. The drive unit 32 for the rotary mirror 31 receives the “move” command from an X—Y table control 63 which is responsible for the X—Y positioning of the wafer 7. The rotary mirror 31 is now rotated by the drive unit 32 until the position-sensitive detector 33′ (FIG. 3) gives the “position reached” signal. The X—Y table control 63 then sends the “stop” signal to the drive unit 32 and, at the same time, sends the “expose” signal to the source module 4. The source module 4 then delivers EUV radiation pulses 45 at a desired pulse repetition frequency (e.g., 10 kHz) until the first exposure field 71 is completely exposed.

Further, the “expose” signal activates a pulse control unit 64 in the exposure system 6 which counts the radiation pulses 45 on the wafer 7 by means of detector 65. The detector 65 detects, e.g., the occurring EUV scatter light and serves as an EUV radiation pulse counter. The signal of the detector 65 gives the pulse control unit 64 the information about the number of exposure pulses 45 which have already been carried out during the scan of the exposure field 71. Further, the pulse control unit 64 supplies information to a central control unit (which can also be integrated in the exposure system 6 but is not shown in FIG. 5) about the radiation pulses 45 which must still be emitted.

When the corresponding number (e.g., 1300 pulses) is reached, the X—Y table control 63 stops the illumination unit 61 and sends a “stop” signal to the source module 4. The X—Y table control 63 provides for the displacement of the wafer 7 to the start position of the second exposure field 71 by means of the X—Y table system 62 and at the same time supplies the “move” signal to the drive unit 32 of the rotary mirror 3. The latter now rotates until it receives the “position reached” signal from the position-sensitive second detector 33″ (FIG. 3). The next optically coupled-in source module 4″ (see FIGS. 1, 4) is then activated by the “expose” command over a period of, e.g., 0.13 s and emits a burst 44 of EUV radiation pulses 45 at the same pulse repetition frequency as the source module 4″ previously for exposing the next exposure field 71 of the wafer 7, and so on.

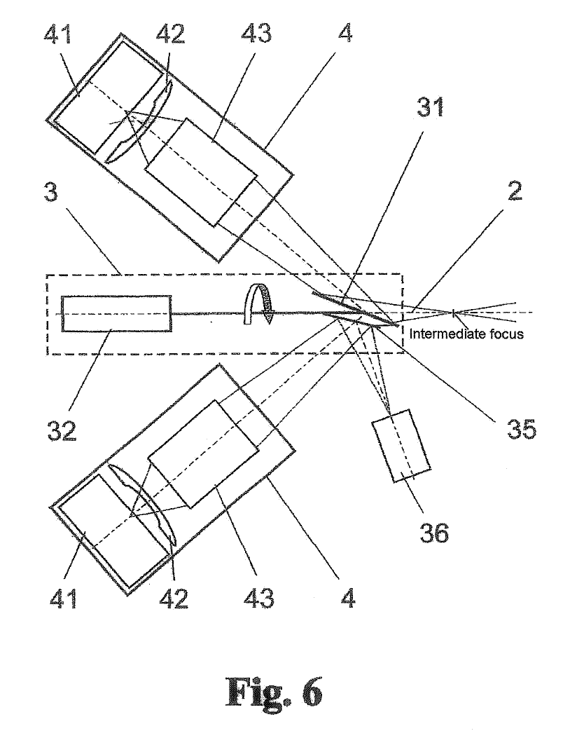

FIG. 6 shows another special construction of the invention with an additional monitoring function for the source modules 4. To simplify the illustration, the entire EUV source is represented again only by two source modules 4′ and 4″ without limiting generality. However, it can also be constructed with three or more source modules 4, advantageously with four source modules 4.

In this case, the reflecting optical element 31 has two parts and comprises a main mirror 35 which, in the present exposure example, reflects the radiation from the source module 4′ in direction of the optical axis 2 to the intermediate focus and an auxiliary mirror 35 which is arranged in such a way that it reflects radiation from the source module 4″ in direction of a monitoring detector 37 via the main mirror 35 (as far as this is necessary or routine) during the exposure process by the source module 4′. In the intervals between exposures by a source module 4″ (e.g., the source module located opposite from the active source module 4′), the state of this source module 4″ (e.g., the measurement of the pulse energy after the collector 43) is monitored by the monitoring detector 37 by briefly putting it into operation before the source module 4″ is used for exposure after triggering the reflector arrangement 3 and orienting the main mirror 35 (while the auxiliary mirror 36 rotates along with it at the same time).

When the auxiliary mirror 36 for the main mirror 35 and the source modules 4′ and 4″ are fixed exactly opposite to one another with respect to the axis of rotation (optical axis 2), the monitoring detector 37 can be constructed simultaneously as a position-sensitive detector 33′ by brief operation of the “inactive” source module 4″ so that it determines the exact orientation of the main mirror 35 to the active source module 4′ and sends the corresponding “stop” signal to the drive unit 32 of the reflector arrangement 3 and the “expose” signal to the active source module 4′.

To sum up, the method according to the invention may be described by the following process regime:

A rotary mirror 31 is not rotated continuously (at constant speed) as is conventional, but in defined steps which are adapted to the positions of the individual source modules 4′, 4″, 4′″, and so on.

A drive unit 32 which can adjust defined incremental angles of rotation on demand (e.g., servo motor or stepper motor with the characteristic properties indicated above) is used for rotating the rotary mirror 31.

During the exposure (e.g., during a burst 44 of, e.g., 1300 pulses 45), the rotary mirror 41 is fixed at an angle in direction of one of the source modules 4′, 4″ or 4′″.

At the end of the exposure process for the first exposure field 71 by a burst 44 of the source module 4′, i.e., during an interval between exposures before the start of the exposure of the next exposure field 71, the drive unit 32 is activated, the rotary mirror 31 rotates until reaching the position of the next source module 4″ and is braked (stopped) at this location to make possible the exposure process for the next exposure field 71. The synchronization of the exposure process and rotating process is carried out by the pulse control 64 of the lithographic exposure system 6, since control signals for displacing the wafer 7 into the position for exposing the next exposure field 71 is likewise sent to the X—Y table system 62 in the intervals between exposures. The stepwise rotating movements of the drive unit 32 are accordingly effected synchronous to the linear movements of the wafer 7. This is easily possible because the displacement of the wafer 7 requires a substantially more exacting adjustment and monitoring of the adjustment of the exposure field 71 than the adjustment of the angle of rotation of the rotary mirror 31.

Because of the very brief stressing of the source modules 4 over time intervals of a few hundredths of a second, the thermal loading for an individual source module 4′ is reasonably small, since brief temperature peaks due to the high pulse repetition frequency (>12 kHz) can be carried off for a sufficiently long time during the exposure times of the other source modules 4″ and 4′″ and during the overhead times between the individual exposure processes for the exposure fields 71. The average thermal loads for the source modules 4 are substantially reduced in this way, namely to an increasing extent the more source modules 4 are arranged so as to be distributed around the axis 2 of the rotary mirror 31.

The low rotating speed of the rotary mirror 31 with the relatively long pauses between rotational movements presents no significant problems for most cooling methods. There is the additional advantage for the entire reflector arrangement 3 that the rotating speed is considerably smaller than in the case of a continuous mirror rotation with individual pulse multiplexing and that existing drive types (stepper motors and servo motors) can be used for this purpose. Stepper motors which displace the wafer 7 at high speed and with great accuracy in the lithographic exposure system 6 after each burst 44 by means of the X—Y table system 62 are equally well suited for the stepwise rotation of the rotary mirror 31, and the mirror rotation has comparatively much lower requirements with respect to adjusting accuracy.

While the foregoing description and drawings represent the present invention, it will be obvious to those skilled in the art that various changes may be made therein without departing from the true spirit and scope of the present invention.

### Reference Numbers

1 vacuum chamber
2 optical axis, axis of rotation
3 reflector arrangement
31 reflecting optical element (rotary mirror)
32 drive unit
33, 33′, 33″ position-sensitive detector
34, 34′, 34″ auxiliary laser beam
35 main mirror
36 auxiliary mirror
37 monitoring detector
4, 4′, 4Δ, 4′″ source modules
41 source unit
42 device for debris suppression (DMT)
43 collector optics
44 burst
45 pulses
5 plasma
6 exposure system (scanner)
61 illumination unit
62 X—Y table system
63 X—Y table control
64 pulse control
65 detector pulse counter)
7 wafer
71 exposure field
72 line focus (moving slit)

What is claimed is:

1. An arrangement for generating EUV radiation of high average output for the lithographic exposure of wafers comprising:
a vacuum chamber being provided for the generation of radiation, said vacuum chamber having an optical axis for the EUV radiation when it exits the vacuum chamber;
a plurality of identically constructed source modules being arranged so as to be distributed around the optical axis of the vacuum chamber, from which source modules a beam bundle generated from EUV radiation-emitting plasma is directed to a common intersection point with the optical axis;
a rotatably mounted reflector arrangement being arranged at the common intersection point of the beam bundles, which reflector arrangement couples the beam bundles prepared by the source modules into the optical axis in series;
said reflector arrangement having a reflecting optical element which is mounted so as to be rotatable around an axis of rotation coaxial to the optical axis and which communicates with a drive unit and is adjustable on demand so as to be stopped temporarily in angular positions that are defined for the source modules; and
said reflector arrangement communicating with an exposure system for lithographic exposure in order to initiate an orientation of the reflecting optical element to the next source module in intervals between exposures by control signals emitted by the exposure system.

2. The arrangement according to claim 1, wherein the drive unit has a rotor which is rotatable around the optical axis by increments, and the reflecting optical element is directly connected to the rotor.

3. The arrangement according to claim 2, wherein a plane mirror is provided as reflecting optical element.

4. The arrangement according to claim 2, wherein a suitably curved mirror is provided as reflecting optical element for additional focusing of the beam bundles of the source modules.

5. The arrangement according to claim 2, wherein a plane optical grating is provided as reflecting optical element.

6. The arrangement according to claim 2, wherein a curved optical grating is provided as reflecting optical element for additional focusing of the beam bundles of the source modules.

7. The arrangement according to claim 1, wherein an additional, auxiliary laser beam and position-sensitive detectors associated with the source modules for detecting and adjusting the angle of rotation of the reflecting optical element are provided.

8. The arrangement according to claim 5, wherein the reflecting optical element is constructed as a meandering grating with a suitable groove depth and grating constant.

9. The arrangement according to claim 5, wherein the reflecting optical element is constructed so as to be spectrally selective for the desired bandwidth of the EUV radiation that is transmissible by the optics downstream.

10. The arrangement according to claim 1, wherein the reflector arrangement has a stepper motor as drive unit.

11. The arrangement according to claim 1, wherein the reflector arrangement is controlled by control signals of position-sensitive detectors in addition to the control signals from the exposure system.

12. The arrangement according to claim 1, wherein the reflector arrangement has two reflecting optical elements, a main mirror and an auxiliary mirror, wherein the main mirror is provided for coupling in the EUV radiation of the active source module along the optical axis and the auxiliary mirror is designed to deflect EUV radiation of a passive source module to a monitoring detector for measuring output parameters.

13. The arrangement according to claim 1, wherein the collector optics used in the individual source modules are grazing incidence optics.

14. The arrangement according to claim 13, wherein the collector optics are a nested Wolter collector.

15. The arrangement according to claim 1, wherein the collector optics used in the individual source modules are multilayer optics.

16. The arrangement according to claim 15, wherein a Schwarzschild collector is used as collector optics.

17. The arrangement according to claim 1, wherein the source units in the individual source modules are constructed as gas discharge sources.

18. The arrangement according to claim 17, wherein gas discharge sources have discharge arrangements with rotary electrodes.

19. The arrangement according to claim 17, wherein the individual source modules have separate high-voltage charging modules.

20. The arrangement according to claim 17, wherein the individual source modules share a common high-voltage charging module.

21. A method for the generation of EUV radiation of high average output for the lithographic exposure of wafers in which a plurality of identically constructed source modules which are arranged in a vacuum chamber so as to be uniformly distributed around an optical axis of the vacuum chamber are triggered successively for generating beam bundles of EUV radiation-emitting plasma in order to couple in their beam bundles in direction of the common optical axis by means of a reflector arrangement which is mounted so as to be rotatable, comprising the following steps:
1) rotating the reflector arrangement for coupling in the beam bundle of a first source module along the optical axis simultaneous with the adjustment of a first exposure field of the wafer in an exposure system for lithographic exposure;
2) triggering the first source module in a burst regime with a high pulse repetition frequency and enough pulses so that the entire first exposure field is completely exposed by pulses from the first source module;
3) rotating the reflector arrangement for coupling in a next source module simultaneous with the adjustment of a next exposure field within an interval between exposures after the preceding exposure of an exposure field;
4) triggering the next coupled-in source module in a burst regime with the same pulse repetition frequency and number of pulses as those for the first exposure field so that the current exposure field is completely exposed with pulses from this source module; and
5) repeating steps 3 and 4, and coupling in all of the source modules one after the other for the complete exposure of a respective exposure field until the last exposure field of the wafer is exposed.
